(19) United States
(12) Patent Application Publication
(10) Pub. No.: US 2018/0262669 A1
(43) Pub. Date: Sep. 13, 2018

(54) IMAGE PICKUP APPARATUS THAT CAUSES LIGHT SOURCE TO EMIT LIGHT WHEN TAKING PHOTOGRAPHS, CONTROL METHOD THEREFOR, AND STORAGE MEDIUM

(71) Applicant: CANON KABUSHIKI KAISHA, Tokyo (JP)

(72) Inventor: Yosuke Mine, Tama-shi (JP)

(21) Appl. No.: 15/913,116

(22) Filed: Mar. 6, 2018

(30) Foreign Application Priority Data
Mar. 10, 2017 (JP) 2017-046266

(51) Int. Cl. H04N 5/235; H04N 5/225; H04N 5/232

(52) U.S. Cl. CPC H04N 5/2354; H04N 5/2256; G01J 1/4209; H04N 5/2351; H04N 5/23241

(57) ABSTRACT

An image pickup apparatus which is capable of properly adjusting flash output of a flash unit when taking a photograph. Brightness information is obtained as a result of test flash firing by the flash unit for illuminating a subject. An amount of light to be emitted for shooting by the flash unit is determined based on the brightness information. The test flash firing is controlled by selecting normal flash firing in which the flash unit fires only for a part of a time period during which electric charge is accumulated so as to perform photometry, and intermittent flash firing in which the flash unit fires throughout the time period during which the electric charge is accumulated. When flash firing with a predetermined intensity or higher is not required for the test flash firing, the intermittent flash firing is selected.

### BACKGROUND OF THE INVENTION

### Field of the Invention

The present invention relates to an image pickup apparatus that causes a light source to emit light when taking photographs, a control method therefor, and a storage medium.

### Description of the Related Art

There is a camera which is known as an image pickup apparatus firing a flash unit when taking photographs. For example, the camera fires a test flash before taking a photograph, performs photometry to meter light reflected by a subject when the test flash was fired, and based on a result of the photometry, adjusts flash output of the flash unit when a photograph is taken (see, for example, Japanese Laid-Open Patent Publication (Kokai) No. 2014-126712). In test flash firing, intensity of light emitted by the flash unit is controlled according to a distance to a subject. For example, in test flash firing for shooting a subject far from the camera, the flash unit fires with high intensity, and more specifically, fires with a large amount of light and for a long flash duration, while in test flash firing for shooting a subject near the camera, the flash unit fires with low intensity, and more specifically, fires with a small amount of light and for a short flash duration.

To properly adjust flash output of the flash unit, it is preferred that in test flash firing, the camera performs photometry with such timing that the amount of light emitted reaches its peak, but the timing varies to some extent when firing of the flash unit is controlled, and it is thus difficult to predict when the amount of light emitted will reach its peak. For this reason, the camera conventionally accumulates electric charge corresponding to light, which is reflected by a subject when a test flash is fired, for a predetermined time period that is a fixed duration regardless of flash intensity of the flash unit and includes a test flash time period, and performs photometry on the accumulated electric charge. Namely, a photometric result in test flash firing includes a photometric result for a time period during which the flash unit does not fire.

However, when the photometric result in test flash firing includes the photometric result for a time period during which the flash unit does not fire, the photometric result includes noise such as ambient light components generated in the time period during which the flash unit does not fire. Particularly when the flash unit fires with low intensity, the photometric result includes a lot of information on the time period during which the flash unit does not fire, and hence there are remarkable effects of the noise. As a result, the conventional camera cannot properly adjust flash output of the flash unit when photographs are taken.

### SUMMARY OF THE INVENTION

The present invention provides an image pickup apparatus and a control method therefor which are capable of properly adjusting flash output when taking photographs, as well as a storage medium.

Accordingly, the present invention provides an image pickup apparatus that uses brightness information, which is obtained as a result of test light emission by a light source for illuminating a subject, to determine an amount of light to be emitted for shooting by the light source, comprising a photometric sensor configured to perform photometry, and a processor configured to control the test light emission by selecting first light emission in which light is emitted only for a part of a time period during which electric charge is accumulated by the photometric sensor, and second light emission in which light is emitted throughout the time period during which the electric charge is accumulated, wherein the processor selects the second light emission when light emission with a predetermined intensity or higher is not required for the test light emission.

According to the present invention, flash output is properly adjusted when photographs are taken.

Further features of the present invention will become apparent from the following description of exemplary embodiments (with reference to the attached drawings).

### BRIEF DESCRIPTION OF THE DRAWINGS

FIG. 1 is a side view showing a camera which is an image pickup apparatus according to an embodiment of the present invention.

FIG. 2 is flowchart showing the procedure of an image pickup control process which is carried out by the camera in FIG. 1.

FIG. 3 is a flowchart showing the procedure of a light amount determination process in step S205 in FIG. 2.

FIG. 4 is a view useful in explaining normal flash firing by the flash unit in FIG. 1.

FIG. 5 is a view useful in explaining intermittent flash firing by the flash unit in FIG. 1.

FIG. 6 is flowchart showing the procedure of a parameter determination process in step S301 in FIG. 3.

FIG. 7 is a view useful in explaining distances reached in main flash firing in the camera in FIG. 1.

FIG. 8 is a view showing an example of a parameter list which is used by the camera in FIG. 1.

### DESCRIPTION OF THE EMBODIMENTS

An embodiment of the present invention will now be described in detail with reference to the accompanying drawings.

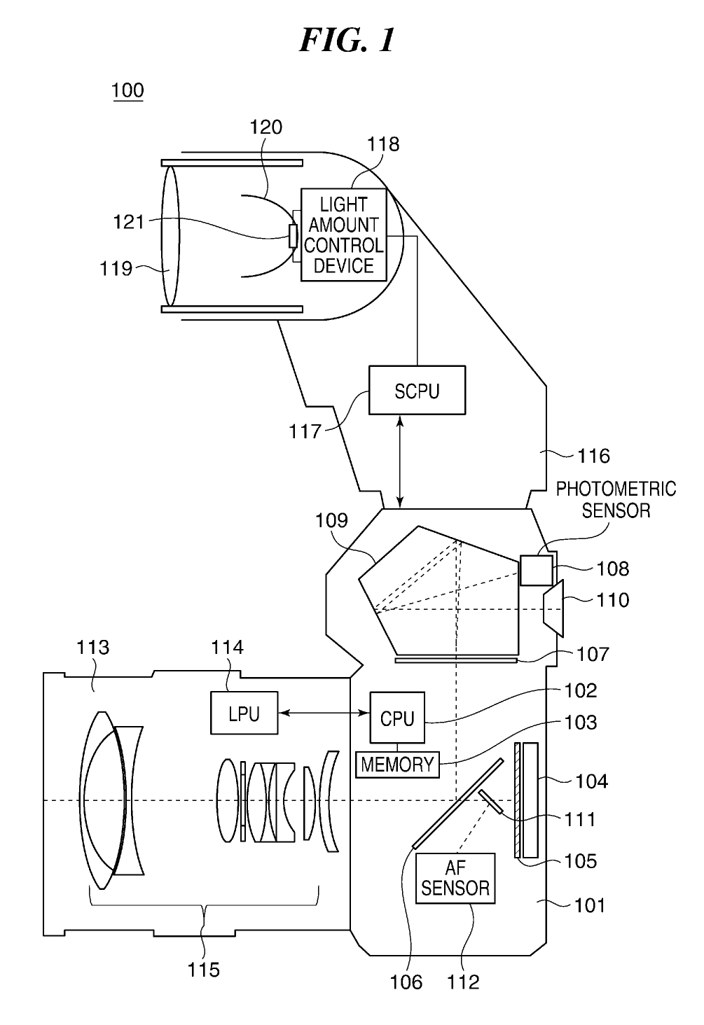

FIG. 1 is a side view showing a camera 100 which is an image pickup apparatus according to the embodiment of the present invention.

Referring to FIG. 1, the camera 100 has a main body 101, a lens unit 113, and a flash unit 116. It should be noted that in FIG. 1, internal component elements are illustrated so that they can be seen through so as to be easily understandable. The main body 101 has a CPU 102, a memory 103, an image pickup unit 104, a shutter 105, a half mirror 106, a focusing screen 107, a photometric sensor 108, a pentaprism 109, an optical viewfinder 110, an AF mirror 111, and an AF sensor 112. The lens unit 113 has an LPU 114 and a lens group 115. The flash unit 116 has an SCPU 117, a light amount control device 118, a zooming optical system 119, a reflective umbrella 120, and a light source 121.

The CPU 102 provides various types of control in the main body 101. The memory 103 is a RAM, a ROM, or the like connected to the CPU 102 and stores programs, which are to be executed by the CPU 102, as well as each piece of data. The image pickup unit 104 is an image pickup device such as a CCD or CMOS including an infrared cut filter, a low-pass filter, and so forth. Light incident from the lens unit 113 forms an image of a subject on the image pickup unit 104. The shutter 105 is able to be opened and closed. When shooting is not performed, the shutter 105 is closed to block light from reaching the image pickup unit 104, and when shooting is performed, the shutter 105 is open to allow passage of light to the image pickup unit 104. When shooting is not performed, the half mirror 106 reflects part of light incident from the lens unit 113 to form an image on the focusing screen 107. The photometric sensor 108 has the image pickup device such as a CCD or CMOS and performs a subject recognition process (hereafter referred to as “the AE process”) such as photometric computations, face detection computations, tracking computations, or light source detection. For example, the photometric sensor 108 converts light guided from the pentaprism 109 into electric charge and accumulates the electric charge throughout a set period of time. The photometric sensor 108 generates an image signal based on the accumulated electric charge and carries out the AE process based on the image signal. The pentaprism 109 causes light, which has passed through the focusing screen 107, to be reflected off the photometric sensor 108 and the optical viewfinder 110. The AF mirror 111 causes a part of light, which is guided from the half mirror 106, to be reflected off the AF sensor 112. The AF sensor 112 outputs a signal corresponding to light guided from the AF mirror 111 to the CPU 102. Based on the signal, the CPU 102 carries out the AE process. Based on the signal, the CPU 102 also measures a distance from the camera 100 to the subject.

The LPU 114 provides control to move the lens group 115 in the lens unit 113. For example, upon receiving an amount of defocus representing an amount by which the lens group 115 is out of focus, the LPU 114 moves the lens group 115 to a position at which the lens group 115 is in focus (hereafter referred to as “the focusing position”) based on the amount of defocus. The SCPU 117 provides various types of control in the flash unit 116. The light amount control device 118 controls light emission of the light source 121. The zooming optical system 119 is comprised of a panel-shaped Fresnel lens or the like and changes a radiation angle of the flash unit 116. The reflective umbrella 120 gathers beams emitted by the light source 121 and radiates the gathered beams onto the subject. The light source 121 is a light-emitting unit for illuminating the subject and is a xenon tube or the like.

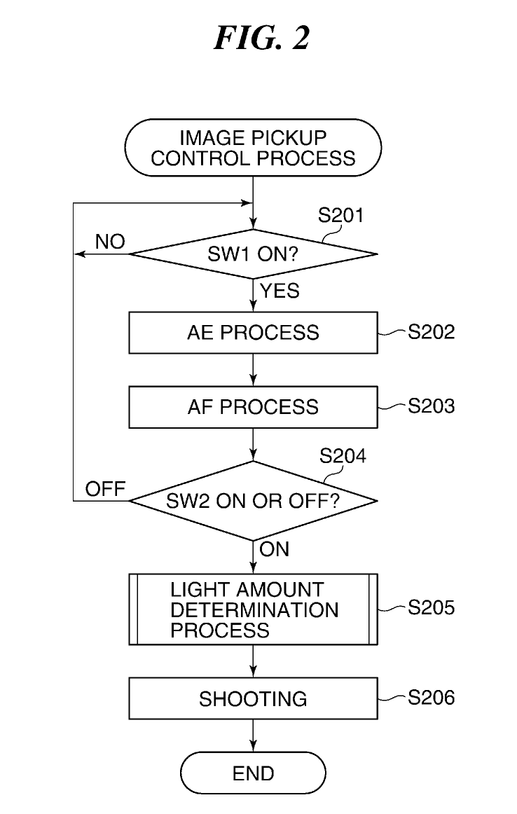

FIG. 2 is flowchart showing the procedure of an image pickup control process which is carried out by the camera 100 in FIG. 1.

The process in FIG. 2 is carried out by the CPU 102 executing programs stored in the memory 103 and based on the assumption that the camera 100 has already been started.

Referring to FIG. 2, first, the CPU 102 receives an on-off notification indicating whether or not a user has pressed a shutter switch (not shown), which gives an instruction to take a photograph, halfway down (hereafter referred to as “the SW1”), and when the SW1 is on (YES in step S201), the CPU 102 controls the photometric sensor 108 to carry out the AE process (step S202). As a result, a photometric value including brightness information on the subject under ambient light (hereafter referred to as “the photometric value under ambient light”) is obtained. Based on the photometric value under ambient light, exposure control values such as f-number and ISO speed for shooting are determined. Next, the CPU 102 controls the AF sensor 112 to carry out a phase difference AF process (step S203). In the AF process, the CPU 102 detects a face of the subject based on an image generated by the photometric sensor 108, measures a distance to the face based on an output from the AF sensor 112, and calculates an amount of defocus based on a result of the measurement. The CPU 102 sends the calculated amount of defocus to the LPU 114. Based on the received amount of defocus, the LPU 114 moves the lens group 115 to the focusing position. Then, the CPU 102 receives an on-off notification indicating whether or not the user has pressed the shutter switch (not shown) all the way down (hereafter referred to as “the SW2”) and determines whether the SW2 is on or off (step S204).

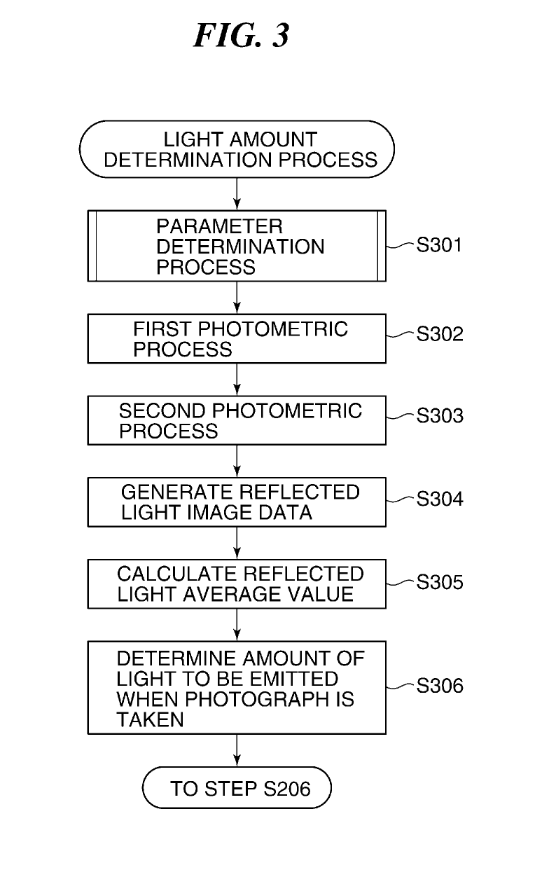

As a result of the determination in the step S204, when the SW2 is off, the CPU 102 returns to the process in the step S201. On the other hand, as a result of the determination in the step S204, when the SW2 is on, the CPU 102 carries out a light amount determination process in FIG. 3, to be described later (step S205) and determines an amount of light the flash unit 116 emits and a flash duration when a photograph is to be taken. After that, the CPU 102 fires the flash unit 116 based on the amount of light and the flash duration determined in the step S205 and performs shooting accompanied by firing of the flash unit 116 (step S206) and ends the present process.

FIG. 3 is a flowchart showing the procedure of the light amount determination process in the step S205 in FIG. 2.

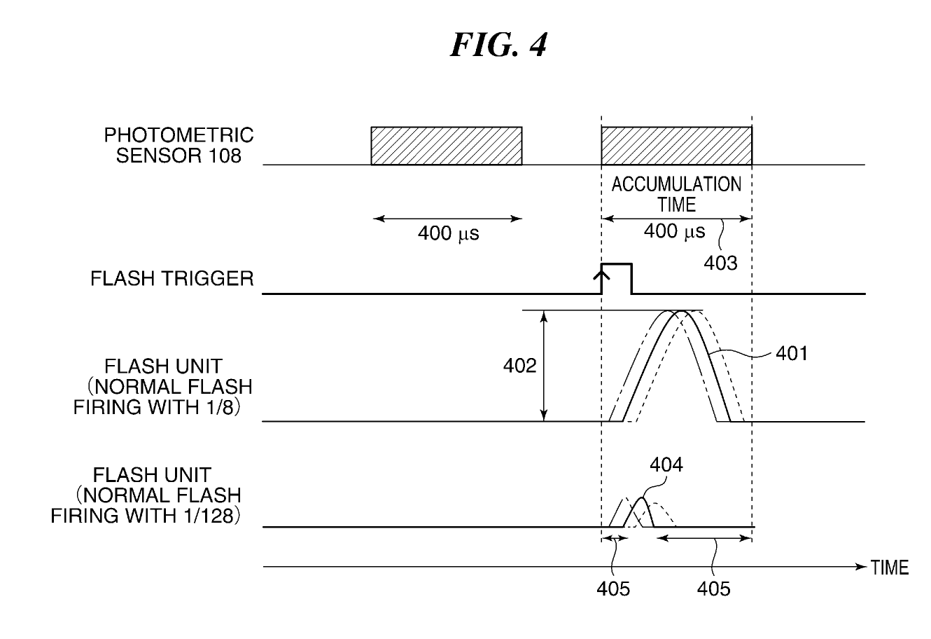

Referring to FIG. 3, the CPU 102 carries out a parameter determination process in FIG. 4, to be described later (step S301) to determine parameters for firing a test flash. Then, the CPU 102 carries out a first photometric process using the photometric sensor 108 (step S302). The first photometric process is carried out immediately before a test flash is fired. In the first photometric process, the photometric sensor 108 accumulates electric charge from when the CPU 102 instructs the photometric sensor 108 to carry out the first photometric process to when an accumulation time period set as a test flash parameter has elapsed, and based on the accumulated electric charge, carries out the AE process. As a result, image data including brightness information on the subject immediately before the test flash firing (preliminary light emission) (hereafter referred to as “the image data immediately before the test flash firing”) is generated. The image data immediately before the test flash firing is stored as a photometric result of the first photometric process in the memory 103. After that, the CPU 102 fires the flash unit 116 based on the parameters determined in the step S301 and carries out a second photometric process using the photometric sensor 108 (step S303). The second photometric process is carried out during the test flash firing. In the second photometric process, the photometric sensor 108 accumulates electric charge from when the CPU 102 instructs the photometric sensor 108 to carry out the second photometric process to when an accumulation time period set as the test flash parameter has elapsed, and based on the accumulated electric charge, carries out the AE process. As a result, image data including brightness information on the subject during the test flash firing (hereafter referred to as “the image data during the test flash firing”) is generated. The image data during the test flash firing is stored as a photometric result of the second photometric process in the memory 103.

Then, the CPU 102 generates reflected light image data based on a difference between the image data during the test flash firing and the image data immediately before the test flash firing (step S304) and stores the reflected light image data in the memory 103. The reflected light image data is cleared of effects from ambient light and includes only brightness components of the subject under the light from the flash unit 116. The CPU 102 then performs averaging computations on the reflected light by using the reflected light image data to calculate a reflected light average value Ys (step S305). For example, when the camera 100 is in a centerweighted flash output adjustment mode in which adjustment of flash output for a central area of a captured image is given high priority, the CPU 102 sets a weighting coefficient for an area near the center of the image to a greater value than a weighting coefficient for an area other than the area near the center of the image. To take an image by using a characteristic area detecting function which the camera 100 is equipped with, the CPU 102 sets a weighting coefficient for a detected characteristic area to a greater value than a weighting coefficient for an area other than the characteristic area. The CPU 102 calculates the reflected light average value Ys based on the set weighting coefficients.

The CPU 102 then performs logarithmic transformation of the reflected light average value Ys to calculate a reflected light brightness value Yslog and calculates a difference between the reflected light brightness value Yslog and a correct brightness value Yt (logarithm), that is, DF=Yslog−Yt. The correct brightness value Yt (logarithm) is data obtained by transforming a value which would be a correct exposure when a photograph is taken into a logarithm. Based on the amount of light emitted in the test flash firing and the difference DF, the CPU 102 determines an amount of light FLASH to be emitted by the flash unit 116 when the photograph is taken (step S306).

FLASH=the amount of light emitted in the test flash firing−DF (Equation 1)

The CPU 102 outputs the determined amount of light FLASH to the SCPU 117 and carries out the processes in the step S206 and the subsequent steps. The flash unit 116 that has received the amount of light FLASH fires with the amount of light FLASH when the photograph is taken.

A description will now be given of a flash firing process by the flash unit 116.

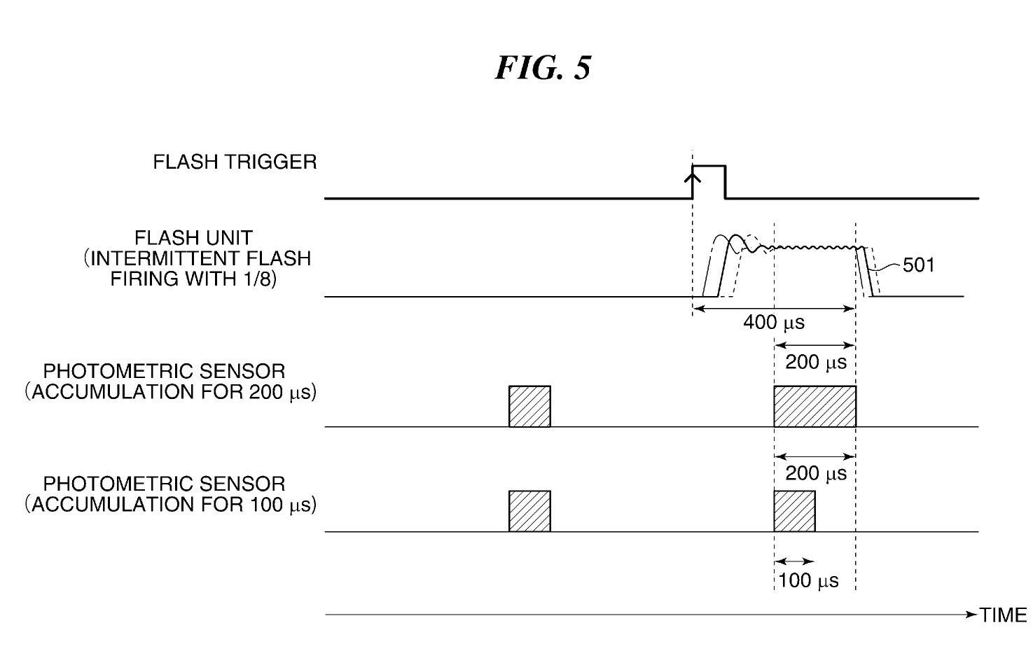

Upon receiving a signal indicating a flash firing instruction (hereafter referred to as “the flash trigger”) from the CUP 102, the flash unit 116 starts the flash firing process i.e. either normal flash firing (first light emission) as shown in FIG. 4 or intermittent flash firing (second light emission) as shown in FIG. 5.

In the normal flash firing, the flash unit 116 fires momentarily with an amount of light set in advance. For example, the flash unit 116 fires with a predetermined amount of light 402 (hereafter referred to as “the peak flash firing”) as represented by a waveform 401 and is then turned off. Ordinarily, in the photometric process, electric charge has only to be accumulated for a time period during which the flash unit 116 fires, but in the normal flash firing, with consideration given to variations in the timing of the peak flash firing, the photometric sensor 108 accumulates electric charge throughout a time period 403 in FIG. 4 that is a fixed duration regardless of the amount of light emitted and also includes the flash duration of the flash unit 116. In other words, in the normal flash firing, the flash 116 fires only for a part of the time period 403 during which electric charge is accumulated. In the normal flash firing, for example, if the amount of light emitted is small as represented by a waveform 404, a photometric result obtained by the photometric sensor 108 would include a lot of information on a time period during which the flash unit 116 does not fire as represented by a time period 405. If noise occurs within a time period during which the flash unit 116 does not fire, a photometric result would include the noise, making it impossible to properly adjust flash output of the flash unit 116 when photographs are taken. For this reason, the normal flash firing is not suitable for flash firing with a small amount of light.

In the intermittent flash firing, intensity of light is controlled according to the flash duration as well as the amount of light emitted. For example, by reducing a flash duration by half, flash firing equivalent to flash firing with a half amount of light is possible even with the same amount of light emitted. In the intermittent flash firing, the flash unit 116 repeatedly fires at high speed. This simulates a long-lasting radiation of light by the flash unit 116, and hence the flash unit 116 fires with a substantially uniform amount of light as represented by a waveform 501 throughout a predetermined time period. Therefore, in the photometric process, stable photometric results are obtained at any time as long as the flash unit 116 is firing. In the intermittent flash firing, the flash unit 116 fires throughout a time period during which electric charge is accumulated. The flash unit 116, however, continues to fire throughout a time period during which no electric charge is accumulated as well, and in particular, when the flash unit 116 fires with a large amount of light, power consumption by firing of the flash unit 116 increases. For this reason, the intermittent flash firing is not suitable for flash firing with a large amount of light.

In the present embodiment, with consideration given to the characteristics of the normal flash firing and the intermittent flash firing, the normal flash firing is performed only when flash firing with a predetermined intensity or higher is required, whereas the intermittent flash firing is performed when flash firing with the predetermined intensity or higher is not required.

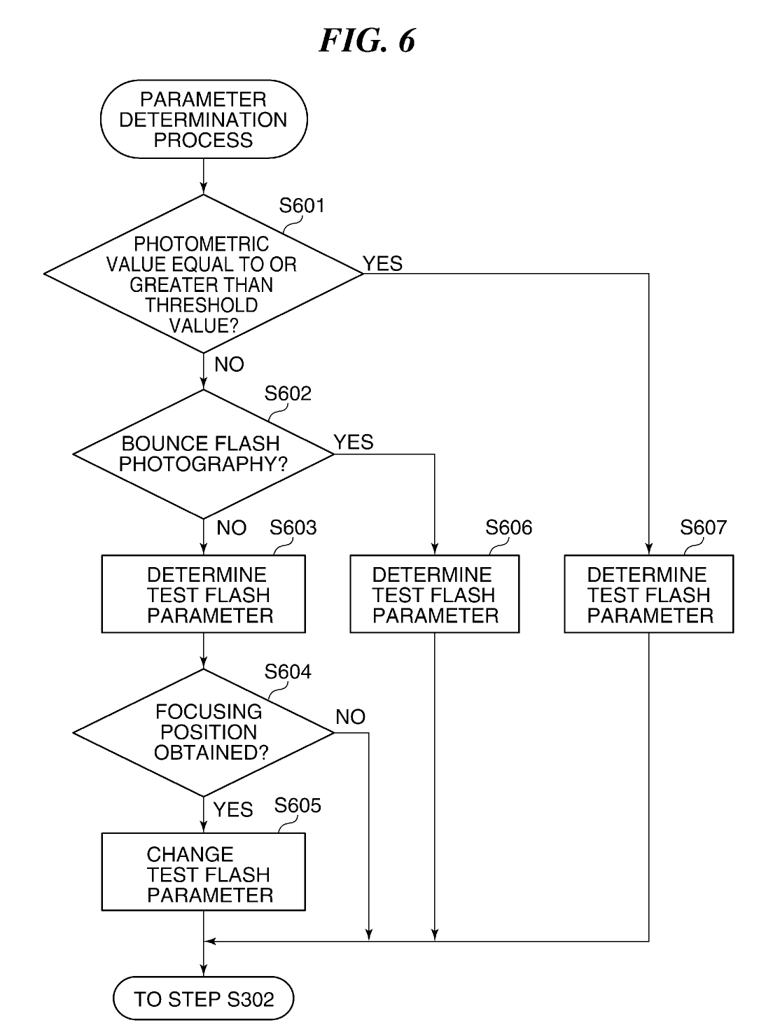

FIG. 6 is flowchart showing the procedure of the parameter determination process in the step S301 in FIG. 3.

Referring to FIG. 6, the CPU 102 compares the photometric value under ambient light obtained in the step S202 with a predetermined threshold value stored in advance in the memory 103 and determines whether or not the photometric value under ambient light is equal to or greater than the predetermined threshold value (step S601).

As a result of the determination in the step S601, when the photometric value under ambient light is smaller than the predetermined threshold value, the CPU 102 determines whether or not a photograph is to be taken with the bounce flash photography (step S602). With the bounce flash photography, light from the flash unit 116 does not directly hit the subject but is bounced off a ceiling, a wall, or the like to illuminate the subject. It should be noted that whether or not a photograph is to be taken with the bounce flash photography should be determined based on bounce information indicating, for example, an orientation of the light source 121 of the flash unit 116 obtained by the CPU 102 communicating with the SCPU 117.

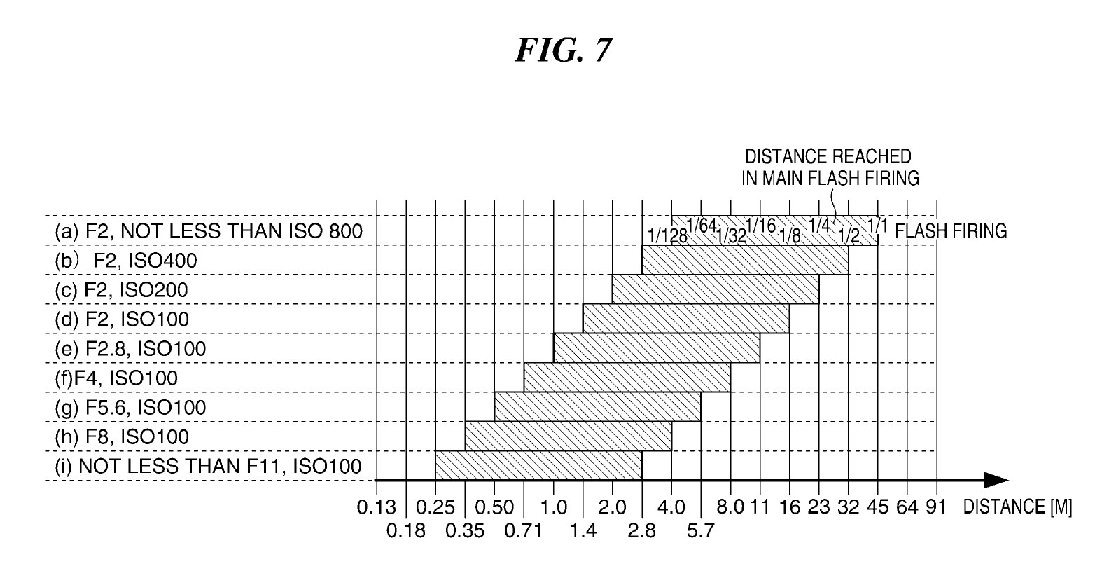

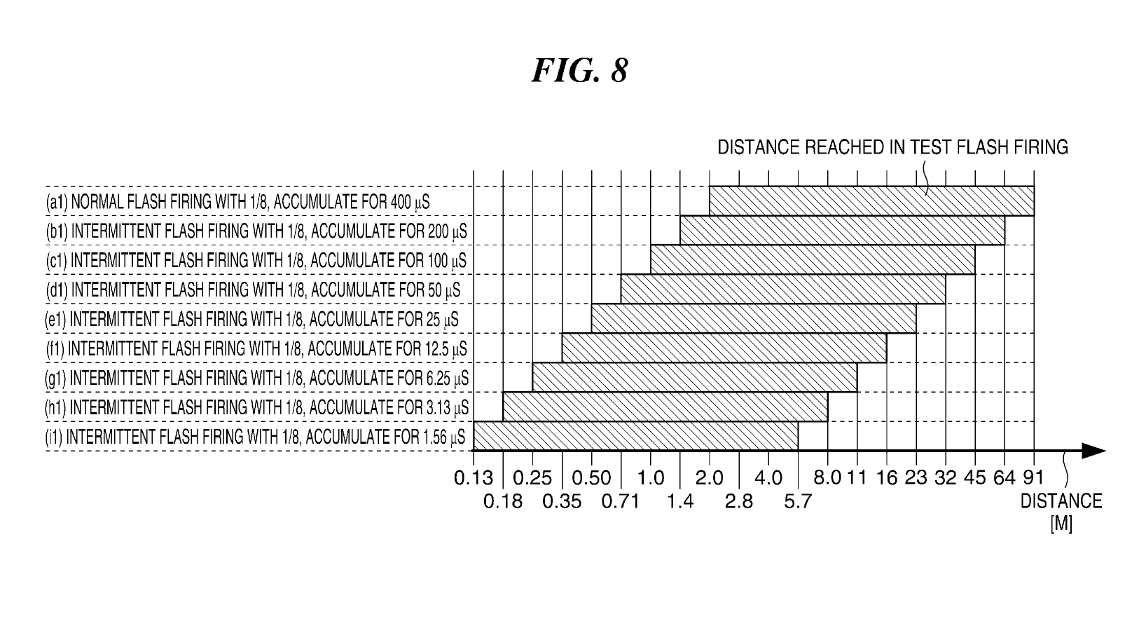

As a result of the determination in the step S601, when a photograph is not to be taken with the bounce flash photography, the CPU 102 obtains a distance reached by a flash fired by the flash unit 116 (hereafter referred to as “the main flash firing”) when the exposure control values for shooting determined by the process in the step S202 were set. It should be noted that the distance reached does not mean a distance to the subject reachable by the light but a distance at which a received amount of light that has been reflected by the subject after reaching the subject is at a predetermined level or higher. In the camera 100, the distance reached in the main flash firing varies with the exposure control values as shown in FIG. 7. For example, the smaller the f-number which is the exposure control value and the higher the ISO speed which is the exposure control value as well, the longer the distance reached in the main flash firing. On the other hand, the greater the f-number which is the exposure control value and the lower the ISO speed which is the exposure control value as well, the shorter the distance reached in the main flash firing. Based on the obtained distance reached in the main flash firing, the CPU 102 selects the test flash parameter from a parameter list 801 in FIG. 8 (step S603). The parameter list 801 includes a plurality of test flash parameters, and each test flash parameter is a combination of information indicating normal flash firing or intermittent flash firing, an amount of light to be emitted, and an electric charge accumulation time. For each test flash parameter, a distance reached by light from the flash unit 116 when the test flash parameter was selected (hereafter referred to as “the test flash reached distance”) is set. In the present embodiment, for example, it is assumed that in the parameter list 801, normal flash firing is indicated only by flash firing with the highest intensity, and intermittent flash firing is indicated by flash firing with the other intensities. In the step S603, the CPU 102 selects the test flash parameter corresponding to the test flash reached distance equivalent to the distance reached in the main flash firing from the parameter list 801. For example, when the exposure control values are an f-number of F2 and an ISO speed of 800 as indicated by (a) in FIG. 7, the distance reached in the main flash firing is 4 m to 45 m. The CPU 102 selects a parameter (a1) with the test flash reached distance of 2 m to 91 m as the test flash parameter corresponding to the exposure control values. Then, the CPU 102 determines whether or not the focusing position has been obtained from the lens unit 113 (step S604).

As a result of the determination in the step S604, when the focusing position has not been obtained, the CPU 102 carries out the processes in the step S302 and the subsequent steps. On the other hand, as a result of the determination in the step S604, when the focusing position has been obtained, the CPU 102 obtains distance information on the subject based on the obtained focusing position and changes the test flash parameter determined in the step S603 to another based on the distance information on the subject (step S605). For example, when the distance to the subject is shorter than the test flash reached distance of 2.0 m (reference distance) for the parameter (a1) determined in the step S603, the CPU 102 changes from the parameter (a1) to a parameter (b1) indicating intermittent flash firing. After that, the CPU 102 carries out the processes in the step S302 and the subsequent steps.

It should be noted that although in the step S604, the distance information on the subject is obtained based on the focusing position, the distance information on the subject may be obtained based on a signal output from the AF sensor 112.

As a result of the determination in the step S602, when a photograph is to be taken with the bounce flash photography, the CPU 102 determines the test flash parameter (step S606). Here, to perform shooting accompanied by firing of the flash unit 116, the camera 100 charges power for firing the flash unit 116 and uses the charged power for the test flash firing and the main flash firing in a distributed manner. For this reason, if too much power is consumed for the test flash firing, power runs short during the main flash firing, and the flash unit 116 cannot fire with desired intensity. On the other hand, in the bounce flash photography, the subject is indirectly irradiated with light, and hence the flash 115 needs to fire with a relatively high intensity. The firing with a relatively high intensity requires a certain level of power, and hence it is preferred that power consumption is minimized in the test flash firing so as to save power for the main flash firing. Accordingly, in the present embodiment, the test flash parameter is selected in the step S606 from another parameter list including many options of the normal flash firing that can reduce power consumption as compared to the intermittent flash firing. After that, the CPU 102 carries out the processes in the step S302 and the subsequent steps.

As a result of the determination in the step S601, when the photometric value under ambient light is equal to or greater than the predetermined threshold value, the CPU 102 determines the test flash parameter (step S607). The case where the photometric value under ambient light is equal to or greater than the predetermined threshold value corresponds to a case where the subject is relatively bright. In this case, when the flash unit 116 fires with high intensity, the photometric sensor 108 that performs photometry becomes saturated with electric charge corresponding to light reflected by the subject, and as a result, flash output cannot be properly adjusted. For this reason, when the photometric value under ambient light is equal to or greater than the predetermined threshold value, it is preferred that a test flash with low intensity is fired. Namely, the intermittent flash firing is more preferable than the normal flash firing. On the other hand, in the step S607, the test flash parameter is selected from a parameter list including only options of the intermittent flash firing. Namely, in the present embodiment, when the photometric value under ambient light is equal to or greater than the predetermined threshold value, the intermittent flash firing is selected. After that, the CPU 102 carries out the processes in the step S302 and the subsequent steps.

According to the present embodiment described above, when flash firing with the predetermined intensity or higher is not required for the test flash firing, the intermittent flash firing is performed. Namely, in the test flash firing with low intensity, the photometric result never includes information on a time period during which the flash unit 116 does not fire. Therefore, the photometric result that does not include noise produced in a time period during which the flash unit 116 does not fire is obtained, and hence flash output is properly adjusted when a photograph is taken.

Moreover, according to the present embodiment described above, the flash unit 116 fires repeatedly at high speed during the intermittent flash firing. As a result, a substantially uniform amount of light is emitted throughout a predetermined time period, and hence a stable photometric result is obtained at any time as long as the flash unit 116 is firing.

Further, according to the present embodiment described above, when the photometric value under ambient light is equal to or greater than the predetermined threshold value or when the distance to the subject is shorter than the predetermined distance, the intermittent flash firing is performed. As a result, in the case where flash firing with a predetermined intensity or higher is not required, i.e., when the photometric value under ambient light is equal to or greater than the predetermined threshold value or when the distance to the subject is shorter than the predetermined distance, flash output is properly adjusted in a reliable manner when a photograph is taken.

It should be noted that although in the present embodiment, when the photometric value under ambient light is equal to or greater than the predetermined threshold value, the test flash parameter is selected from the parameter list including only options of the intermittent flash firing, the present invention is not limited to this. For example, in a case where the camera 100 is equipped with other flash units firing in synchronization with the flash unit 116, those flashes do not need to fire with high intensity. In this case, the test flash parameter is selected from the parameter list including only options of the intermittent flash firing as well. Therefore, even in the case where the camera 100 is equipped with other flash units firing in synchronization with the flash unit 116, flash output is properly adjusted.

Moreover, although in the present embodiment described above, the parameter list 801 includes the parameter indicating the normal flash, all the parameters may be those indicating the intermittent flash firing. Namely, to take a photograph with the bounce flash photography, the intermittent flash firing is performed.

Further, in the present embodiment described above, the flash unit 116 may not only have the light source 121, which is the xenon tube, but also have another light source such as an LED that consumes a smaller amount of power than the xenon tube. In this case, the flash unit 116 uses the light source 121 for the normal flash firing and uses the LED for the intermittent flash firing. This would reduce power consumption in the intermittent flash firing that consumes a larger amount of power than the normal flash firing.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-046266, filed Mar. 10, 2017, which is hereby incorporated by reference herein in its entirety.

What is claimed is:

1. An image pickup apparatus that uses brightness information, which is obtained as a result of preliminary light emission by a light source for illuminating a subject, to determine an amount of light to be emitted for shooting by the light source, comprising:
a photometric sensor configured to perform photometry; and
a processor configured to control the preliminary light emission by selecting first light emission in which light is emitted only for a part of a time period during which electric charge is accumulated by the photometric sensor, and second light emission in which light is emitted throughout the time period during which the electric charge is accumulated,
wherein the processor selects the second light emission when light emission with a predetermined intensity or higher is not required for the preliminary light emission.

2. The image pickup apparatus according to claim 1, wherein in the second light emission, light is emitted repeatedly at high speed.

3. The image pickup apparatus according to claim 1, wherein the processor selects the second light emission when a photometric value obtained as a result of the photometry by the photometric sensor is equal to or greater than a threshold value set in advance.

4. The image pickup apparatus according to claim 1, wherein the processor selects the second light emission in a case where a photograph is not to be taken with bounce flash photography in which a photograph is taken by indirectly irradiating the subject with light from the light source.

5. The image pickup apparatus according to claim 1, wherein the processor selects the second light emission in a case where a distance to the subject is shorter than a reference distance set in advance.

6. The image pickup apparatus according to claim 1, wherein the processor selects the second light emission in a case where the image pickup apparatus is equipped with another light source that emits light in synchronization with the light source.

7. The image pickup apparatus according to claim 1, wherein the light source includes a xenon tube and an LED, and in the first light emission, light is emitted by the xenon tube, while in the second light emission, light is emitted by the LED.

8. A control method for an image pickup apparatus that uses brightness information, which is obtained as a result of preliminary light emission by a light source for illuminating a subject, to determine an amount of light to be emitted for shooting by the light source, comprising:
a photometry step of performing photometry; and
a control step of controlling the preliminary light emission by selecting first light emission in which light is emitted only for a part of a time period during which electric charge is accumulated so as to perform the photometry, and second light emission in which light is emitted throughout the time period during which the electric charge is accumulated,
wherein in the control step, the second light emission is selected when light emission with a predetermined intensity or higher is not required for the preliminary light emission.

9. A non-transitory computer-readable storage medium storing a program for causing a computer to execute a control method for an image pickup apparatus that uses brightness information, which is obtained as a result of preliminary light emission by a light source for illuminating a subject, to determine an amount of light to be emitted for shooting by the light source, the control method for the image pickup apparatus comprising:
a photometry step of performing photometry; and
a control step of controlling the preliminary light emission by selecting first light emission in which light is emitted only for a part of a time period during which electric charge is accumulated so as to perform the photometry, and a second light emission in which light is emitted throughout the time period during which the electric charge is accumulated,
wherein in the control step, the second light emission is selected when light emission with a predetermined intensity or higher is not required for the preliminary light emission.
